(19) United States
(12) Patent Application Publication
(10) Pub. No.: US 2016/0346863 A1
(43) Pub. Date: Dec. 1, 2016

(54) SYSTEM AND METHOD FOR VOICE CONTROLLED WELD OPERATIONS

(71) Applicant: Charles Desranleau, Dapp (CA)

(72) Inventor: Charles Desranleau, Dapp (CA)

(21) Appl. No.: 14/723,051

(22) Filed: May 27, 2015

(51) Int. Cl. B23K 9/10

(52) U.S. Cl. CPC B23K 9/1087

(57) ABSTRACT

The invention is a system and method for controlling welding of a welding unit in which a welding gun is operatively associated with a welding unit, and a microphone is associated with a receiver and a voltage controller is configured to adjust voltage based on vocal commands received by said receiver.

### BACKGROUND OF THE INVENTION

The welding activity is one that includes many industries. Experienced welders know how to perform their craft by sight and sound of the weld arc in a welding gun. Most times, an experienced welder makes adjustments during the welding operation. However, this becomes problematic as the welder often must interrupt their welding in order to use a free hand to make adjustments, or a second person must be available to make adjustments at the command of the welder. The present invention provides a system and method for making adjustments in the welding operation using voice commands.

### SUMMARY OF THE INVENTION

In one embodiment, the present invention is a voice activated remote for a high-low heat, while the welder is welding. It would be hands free for the welder, if the welder would need 10 high or 10 low he would voice activate it and the welder's helper would not have to adjust the welder manually.

Currently, adjustments are performed manually by turning the knob for the high-low heat and it gives the welder full control of his heat he needs to make a perfect weld the welder can also work alone would not have to depend on a helper.

The voice activated remote would change the every day work for any welder there would be one less line of communication needed to complete the job. Example, if a welder says up 10 and if the helper does not hear him you have a human error and with the voice activated device you would ensure a perfect weld and solve this problem.

In one embodiment, the present invention is a system for controlling welding, said system comprising: a welding unit; a welding gun operatively associated with said welding unit; a microphone; a receiver; and a voltage controller operatively associated with said receiver, whereby said voltage controller is configured to adjust voltage based on vocal commands received by said receiver.

In one embodiment, the voltage controller raises or lowers output voltage to the welding gun upon receipt of a voice command.

In one embodiment, the voltage controller disrupts all voltage to the welding gun upon receipt of a voice command and the welding gun ceases operation. This is an important and novel feature in that the entire weld operation can be ceased quickly with a voice command. In case of emergency, the voice command is a very significant safety feature. Currently, there is no such system in the welding industry.

### BRIEF DESCRIPTION OF THE SEVERAL VIEWS OF THE DRAWING

FIG. 1 is demonstrative of the components of one embodiment of the present invention.

FIG. 2 is demonstrative of the conventional control of welding in which the present invention is providing improvement.

FIG. 3 is a flow chart detailing the sequence of operations.

FIG. 4 is a continuation of the flow chart from FIG. 3.

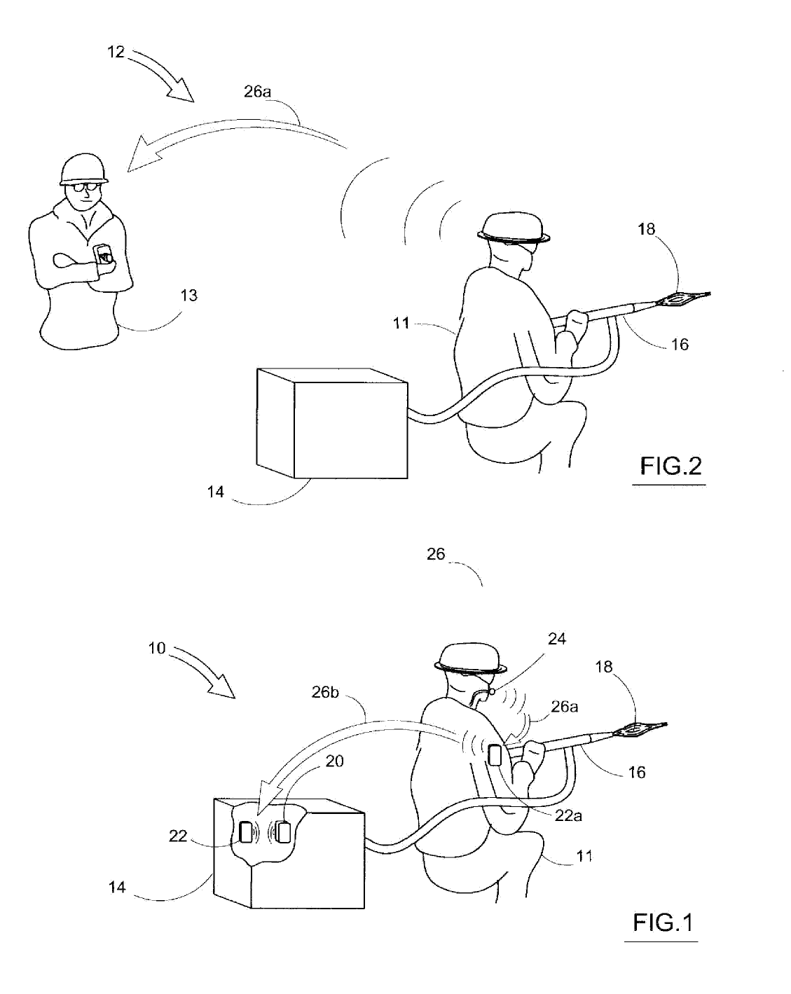

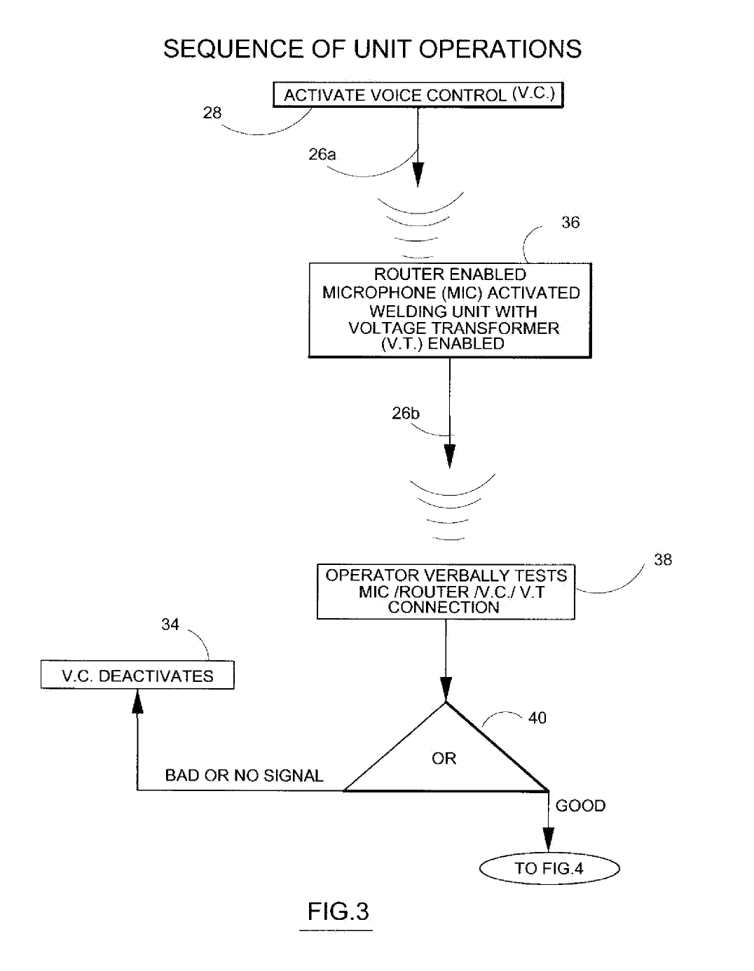

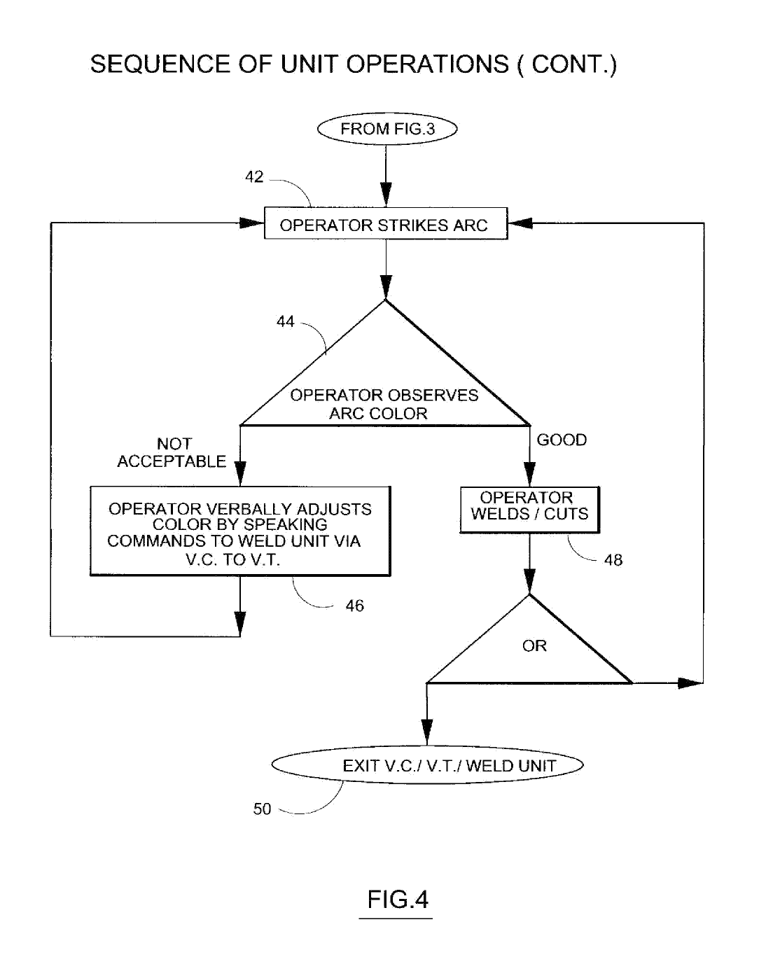

### DETAILED DESCRIPTION OF THE PREFERRED EMBODIMENT

The present invention provides for a person involved in welding activity to use voice commands that provide for adjustments in real time without having to interrupt the welding activity. Typically, as is done today and demonstrated in FIG. 2, a person 11 holding a welding gun 16 with a weld arc 18 attached to weld unit 14 will make adjustments either by interrupting their weld or by communication a voice signal audible to a second person 13 that will make subsequent adjustments. This is very inefficient. The system of the present invention provides that person 11 is provided with a wireless microphone 24 that is operatively associated with a transmitter 22a, such that a voice command 26a is sent to transmitter 22a, and a transmission signal 26b is received by a receiver 20 that controls controller 22 in welding unit 14. In this configuration, weld system 10 is controlled for adjustments by voice command, and thus prevents the need for person 11 to interrupt the welding operation.

As generally understood, the method of the present invention includes activating a voice control unit 28 and sending a voice command to a router-enabled microphone, whereby the signal is sent to an activated welding unit with voltage transformer enablement. Voice signal 26b provides for an operator to verbally test the microphone router, voice control and voltage transformer connections. If the signal is not good, voice connection deactivates.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

What is claimed is:

1. A system for controlling welding, said system comprising:
a welding unit; a welding gun operatively associated with said welding unit; a microphone; a receiver; and a voltage controller operatively associated with said receiver, whereby said voltage controller is configured to adjust voltage based on vocal commands received by said receiver.

2. The system of claim 1 wherein said voltage controller raises or lowers output voltage to the welding gun upon receipt of a voice command.

3. The system of claim 1 wherein said voltage controller disrupts all voltage to the welding gun upon receipt of a voice command and the welding gun ceases operation.
